(19) United States
(12) Patent Application Publication
(10) Pub. No.: US 2010/0056695 A1
(43) Pub. Date: Mar. 4, 2010

(54) COMPOSITE PARTS FOR AIRPLANE ENGINES

(75) Inventors: Gregory R. Alms, Leesburg, FL (US); Martin W. Prellwitz, North Royalton, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/549,482

(22) Filed: Aug. 28, 2009

Related U.S. Application Data
(60) Provisional application No. 61/092,920, filed on Aug. 29, 2008.

(51) Int. Cl. C08K 3/04

(52) U.S. Cl. 524/495

(57) ABSTRACT

This invention relates to a composite ring or segment of a ring, having use as a shroud of an airplane engine, comprising about 20 to about 70 weight percent of the thermoplastic polymer and about 30 to about 80 weight percent of the carbon fiber, and having a heat deflection temperature of at least 230° C. at 1.8 MPa as determined according to ASTM D648, and which provides thermal stability and wear resistance.

### CROSS-REFERENCE TO RELATED APPLICATIONS

This application claims the benefit of U.S. Provisional Application No. 61/092,920, filed Aug. 29, 2008, which is incorporated herein by reference in its entirety.

### FIELD OF THE INVENTION

The present invention is directed to composite airplane engine parts, and particularly to parts that are rings or segments of rings such as shrouds or segments of shrouds.

### BACKGROUND OF THE INVENTION

Airplane engines require parts that are wear resistant, thermally stable and light in weight. Many airplane engines make use of an axial compressor to compress the incoming air before the air is passed to the combustor section of the engine. The axial compressor uses alternating rows of rapidly rotating blades, i.e., rotors, and rows of stator vanes that are fixed and do not rotate. The combined action of the rotor blades and the stator vanes increases the air pressure. The stator vanes can be variable, i.e., they may turn or pivot on their longitudinal axis, to allow better control of airflow and pressure. A row of rotors and a row of stators is referred to as a stage. An axial compressor typically has several stages. The stator vanes are held radially between the outer engine casing and an inner shroud. The inner shroud is fixed in place about the rotating shaft of the engine. The vane end, referred to as a spindle or trunnion, fits in a recess machined into the inner shroud. When the shroud and the vanes are both composed of metal, wear can occur between the vane spindle and the inner shroud.

There is a need for airplane engine parts that are lighter than metal, thermally stable and wear resistant. Polymeric materials having high temperature resistance and wear resistance, such as polyimides and other polymers available from DuPont Co., Wilmington, Del. can be used to reduce metal-to-metal wear.

### BRIEF DESCRIPTION OF THE DRAWING

FIG. 1 shows a representation of a segment of an inner shroud.

### SUMMARY OF THE INVENTION

This invention provides a composite ring or segment of a ring for an aircraft engine, said composite comprising about 20 to about 70 weight percent thermoplastic polymer and about 30 to about 80 weight percent carbon fiber, wherein said composite has a heat deflection temperature of at least 230° C. at 1.8 MPa as determined according to ASTM D648, wherein said carbon fiber is from about 100 μm to about 5 cm in length and wherein said composite ring or segment of a ring is a suitable replacement for a metal ring or segment of a metal ring.

In one embodiment, this invention provides a composite ring or segment of a ring for the shroud of an aircraft engine, the composite further comprising up to about 50 weight percent particulate.

In one embodiment, the composite ring or segment of a ring is a shroud or a segment of a shroud that is used with variable vanes.

### DETAILED DESCRIPTION OF THE INVENTION

Disclosed herein is a composite ring or segment of a ring is prepared from a composite comprising a thermoplastic polymer and carbon fiber. Additionally, the composite may contain particulate to impart additional properties, as described herein below. The ring part described herein may consist of a single piece to make up the ring, or it may consist of more than one ring segment to form the ring. One use for such a ring in an airplane engine is as a shroud, or as an inner shroud.

The composite comprises about 20 to about 70 weight percent of the thermoplastic polymer and about 30 to about 80 weight percent of the carbon fiber wherein the total of all components of the composite is 100 weight percent. Preferably, the composite comprises about 30 to about 60 weight percent of the polymer and about 40 to about 70 weight percent of carbon fiber. The composite may further comprise up to 50 weight percent of particulate.

The thermoplastic polymer is selected from the group consisting of polyimide, polyarylketone (such as polyetheretherketone, PEEK, and polyetherketoneketone, PEKK), polyetherimide, polyamide imide, and blends thereof. Preferably, the polymer is a polyimide. A polyimide provides a preferred combination of high temperature oxidation resistance and both low and high temperature wet and dry mechanical property retention and dimensional stability.

Polyimides useful in the instant invention consist primarily of recurring units of the formula:

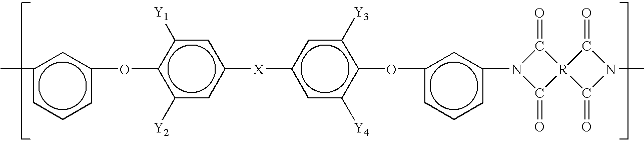

wherein X represents a covalent bond or a radical selected from the group consisting of a C.sub.1-C.sub.10 divalent hydrocarbon radical, a hexafluorinated isopropylidene radical, a carbonyl radical, a thio radical and a sulfonyl radical; Y₁, Y₂, Y₃ and Y₄ may be the same or different and represent a radical selected from the group consisting of a hydrogen atom, a lower alkyl radical, a lower alkoxy radical, a chlorine atom and a bromine atom; and R represents a tetravalent radical selected from the group consisting of an aliphatic radical having two or more carbon atoms, a cyclic aliphatic radical, a monocyclic aromatic radical, a fused polycyclic aromatic radical, and a polycyclic aromatic radical wherein the aromatic rings are linked together directly or via a bridged member.

As described in detail in U.S. Pat. No. 5,013,817, which is incorporated herein by reference, the process for preparing an above-described polyimide comprises reacting:
(a) an aromatic diamine represented by the formula (I):

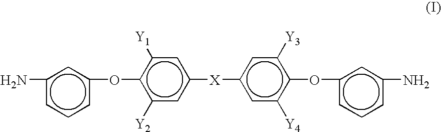

wherein X, Y₁, Y₂, Y₃ and Y₄ have the same meanings as set forth above,
(b) a tetracarboxylic dianhydride represented by the formula (II):

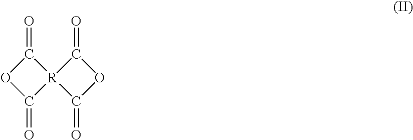

wherein R is as defined above, and

(c) a monoamine represented by the formula (III):

Z—NH₂ (III)

wherein Z represents a monovalent radical selected from the group consisting of an aliphatic radical, a cyclic aliphatic radical, a monocyclic aromatic radical, a fused polycyclic aromatic radical, and a polycyclic aromatic radical wherein the aromatic rings are linked together directly or via a bridged member to form a polyamide, and dehydrating or imidizing the polyamic acid to form a polyimide.

Preferably, the molar ratio of the aromatic diamine is from about 0.9 to about 1.0 mole per mole of tetracarboxylic dianhydride. Preferably the molar ratio of the monoamine is from about 0.001 to about 1.0 mole per mole of tetracarboxylic dianhydride.

Preferred aromatic diamines for use in the process for making the polyimides are selected from the group consisting of 4,4′-bis(3-aminophenoxy)biphenyl, 2,2-bis[4-(3-aminophenoxy)phenyl]propane, bis[4-(3-aminophenoxy)phenyl]ketone, bis(4-(3-aminophenoxy)phenyl]sulfide and bis[4-(3-aminophenoxy)phenyl]sulfone are employed. The diamine compounds employed may be used singly or in combination.

Preferred tetracarboxylic dianhydrides for use in the process for making the polyimides include pyromellitic dianhydride, 3,3′4,4′-benzophenonetetracarboxylic dianhydride, 3,3′,4,4′-biphenyltetracarboxylic dianhydride, bis(3,4-dicarboxyphenyl)ether dianhydride and 4,4′-(p-phenylenedioxy)diphthalic dianhydride. The tetracarboxylic dianhydride compounds employed may be used singly or in combination.

Preferred monoamines for use in the process for making the polyimides include n-propylamine, n-butylamine, n-hexylamine, n-octylamine, cyclohexylamine, aniline, 4-aminobiphenyl, 4-aminophenyl phenyl ether, 4-aminobenzophenone, 4-aminophenyl phenyl sulfide and 4-aminophenyl phenyl sulfone. The monoamine compounds employed may be used singly or in combination.

Also useful as the thermoplastic polymer are the class of polyetherketones which contain the recurring unit (IV):

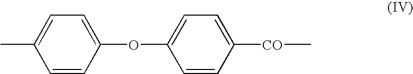

Such polymers may contain the unit (IV) as the sole repeating unit or in conjunction with the repeating unit (V):

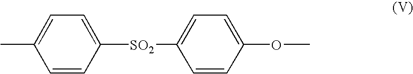

A preferred polyetheretherketone has the repeating unit (VI):

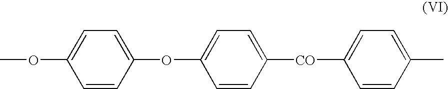

either alone or in conjunction with other repeating units. The other repeating units present in the polymers may be of the repeating unit (VII):

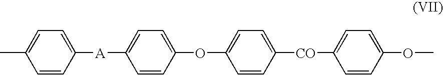

where A is a direct link, oxygen, sulfur, —SO₂—, —CO— or a divalent hydrocarbon radical. The repeat units may also be of formula (VIII):

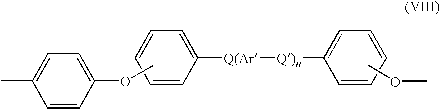

where the oxygen atoms in the sub-units:

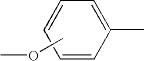

are ortho or para to the groups Q and Q′. The groups Q and Q′ which may be the same or different are —CO— or —SO₂. Ar′ is a divalent aromatic radical, and n is 0, 1, 2 or 3. The polymer of repeat unit VI is the particularly preferred PEEK.

Another polyarylketone that is useful as the thermoplastic polymer is PEKK with the repeat unit (IX):

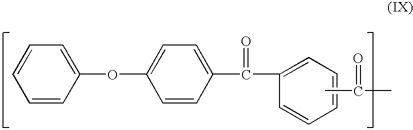

wherein 70 to 95 percent of the

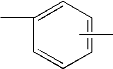

moieties are

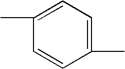

and 5 to 30 percent are

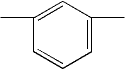

Polyetherimides including the polysulfone etherimides disclosed in WO2007/078737, which is incorporated herein by reference are also useful as the thermoplastic polymer of the present invention.

The carbon fiber and any particulate that is present are mixed with the polymer during the polymer formation process or during the processing of the polymer to form the composite ring or ring segment. The latter process can be, e.g., compression molding, powder compression, injection molding, extrusion molding, reaction injection molding, TPF Thermoplastic Flowforming™ (Envirokare Tech Inc., New York, N.Y.) or any other conventional process for making such articles.

The carbon fiber is from about 100 μm to about 5 cm in length, preferably from about 0.2 cm to about 5 cm in length. The carbon fiber may be either pitch or polyacrylonitrile (PAN) or any other fiber from which a high performance carbon fiber can be made. It may contain a sizing.

The composite part may also contain up to 50 weight percent of particulates. The particulate can be of various types, e.g. graphite, poly(tetrafluoroethylene)homopolymer and copolymers, or mineral fillers, as long as the heat deflection temperature requirement in the composite is met. Talc, mica, wollastonite, kaolinite and sepiolite are preferred mineral fillers.

The composite may also include other fillers including one or more lubricants, antioxidants, color or UV stabilizers and processing aids. These fillers in include additives suitable for optional use in a composition hereof may include, without limitation, one or more of the following: pigments; antioxidants; materials to impart a lowered coefficient of thermal expansion; materials to impart high strength properties e.g. glass fibers, ceramic fibers, boron fibers, glass beads, whiskers, graphite whiskers or diamond powders; materials to impart heat dissipation or heat resistance properties, e.g. aramid fibers, metal fibers, ceramic fibers, whiskers, silica, silicon carbide, silicon oxide, alumina, magnesium powder or titanium powder; materials to impart corona resistance, e.g. natural mica, synthetic mica or alumina; materials to impart electric conductivity, e.g. carbon black, silver powder, copper powder, aluminum powder or nickel powder; materials to further reduce wear or coefficient of friction, e.g. boron nitride. Fillers may be added as dry powders to the final resin prior to parts fabrication.

The composite of the invention has good mechanical properties at elevated temperatures. A measure of this is its heat deflection temperature (HDT) of at least 230° C. at 1.8 MPa as determined according to ASTM D648. The heat deflection temperature (or heat distortion temperature) is a measure of a polymer's resistance to distortion under a given load, i.e., 1.8 MPa, at elevated temperatures. The test specimen is loaded into a 3-point loading apparatus that provides a stress of 1.8 MPa. The temperature is increased and the heat defection temperature is the temperature at which the specimen deflects 0.25 mm. For example, the thermoplastic polyimide DuPont™ Vespel® TP-8549 (available from DuPont Co., Wilmington, Del.) has a HDT of 236° C. at 1.8 MPa.

The composite of this invention has a somewhat reduced dynamic coefficient of friction. As a result, in the case of a composite shroud and a vane making direct contact, less force is needed to move the vane.

The composite ring or segment of a ring described herein is useful as airplane engine parts due to wear-resistance, thermal stability and lighter weight when compared to with traditional parts made of metal. Accordingly, the composite part of the present invention is useful to replace metal parties having the same or similar application or use. The composite ring or segment of a ring results in a weight savings of 40-75% compared to a similar metal ring or segment of a ring, i.e., the weight of the composite part is 25-60% of the weight of a similar metal part. When the composite ring or segment of a ring is a shroud or a segment of a shroud, respectively, used with metal variable vanes, the composite reduces or eliminates wear on the vane stems. The composite enables the elimination of bushings between the composite parts as well as between a composite part and a metal part, e.g., between a composite inner shroud and a metal vane so that there is direct contact between the composite inner shroud and the metal vane. This simplifies assembly by having fewer parts. The composite provides longer life due to the elimination of metal-on-metal wear and the elimination of bushing wear. The composite allows tighter component fits which reduces air leakage around vane stems.

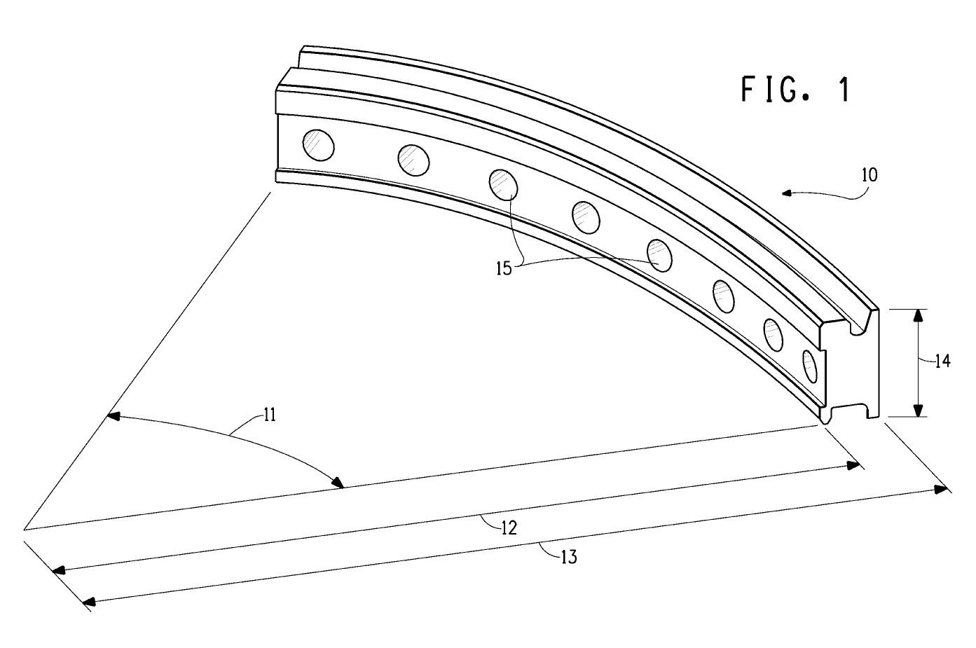

FIG. 1 shows a representation of a typical segment of an inner shroud 10. The segment is in the form of an arc subtending an angle 11. A complete shroud subtends an angle of 360°. A segment of a shroud subtends an angle of a fraction of 360°. The segment of the shroud has an inner radius 12 and an outer radius 13. The segment has a width 14 and contains holes 15 for holding vanes.

What is claimed is:

1. A composite ring or segment of a ring for an aircraft engine, said composite comprising about 20 to about 70 weight percent of a thermoplastic polymer selected from the group consisting of polyimide, polyarylketone, polyether imide, polyamide imide, and blends thereof and about 30 to about 80 weight percent of carbon fiber, wherein said composite has a heat deflection temperature of at least 230° C. at 1.8 MPa as determined according to ASTM D648, wherein said carbon fiber is from about 100 μm to about 5 cm in length and wherein said composite ring or segment of a ring is a suitable replacement for a metal ring or segment of a metal ring.

2. The composite ring or segment of a ring of claim 1, wherein said carbon fiber (b) is from about 0.2 cm to about 5 cm in length.

3. The composite ring or segment of a ring of claim 1, said composite further comprising up to about 50 weight percent particulate selected from the group consisting of graphite, polytetrafluoroethylene, and mineral fillers.

4. The composite ring or segment of a ring of claim 1, said composite comprising about 30 to about 60 weight percent of said thermoplastic polymer and about 40 to about 70 weight percent of said carbon fiber.

5. The composite ring or segment of a ring of claim 1, wherein said thermoplastic polymer is a polyimide.

6. The composite ring or segment of a ring of claim 4, wherein said thermoplastic polymer is a polyimide.

7. The composite ring or segment of a ring of claim 5, wherein said composite ring or segment of a ring is an inner shroud or a segment of an inner shroud having use with variable vanes.

8. The composite ring or segment of a ring of claim 2, wherein said composite ring or segment of a ring is an inner shroud or a segment of an inner shroud having use with variable vanes.

9. The shroud or segment of an inner shroud of claim 7, wherein said shroud is suitable for use in, or is in use in, an airplane engine.

10. The shroud of claim 7, wherein said composite further comprising up to about 50 weight percent particulate selected from the group consisting of graphite, polytetrafluoroethylene, and mineral fillers.
